(19) United States
(12) Patent Application Publication
(10) Pub. No.: US 2025/0232697 A1
(43) Pub. Date: Jul. 17, 2025

(54) MULTISENSORY ART APPARATUS AND METHOD

(71) Applicants: Vineet Kheradia, Carmel, IN (US); Dhairya Shah, Carmel, IN (US); Vriddhi Doshi, Carmel, IN (US); Shivansh Singh, Carmel, IN (US); Ojaswini Tomar, Carmel, IN (US); Prachi Pandya, Carmel, IN (US)

(72) Inventors: Vineet Kheradia, Carmel, IN (US); Dhairya Shah, Carmel, IN (US); Vriddhi Doshi, Carmel, IN (US); Shivansh Singh, Carmel, IN (US); Ojaswini Tomar, Carmel, IN (US); Prachi Pandya, Carmel, IN (US)

(21) Appl. No.: 19/022,966

(22) Filed: Jan. 15, 2025

Related U.S. Application Data
(60) Provisional application No. 63/621,356, filed on Jan. 16, 2024.

(51) Int. Cl. G09F 27/00; B44C 5/04

(52) U.S. Cl. CPC G09F 27/00; B44C 5/04

(57) ABSTRACT

A multi-sensory art system includes an artistic medium with one or more of a tactile element, a sound element, a fragrance element, and/or an immersive element. Touch sensors may activate features such as speakers, fragrance misters, heating, and/or cooling components, providing individuals with sensory disabilities an interactive way to experience art.

### FIELD

The present disclosure relates to a multi-sensory art system and more particularly to an art piece having various sections to allow a person with sensory disabilities to observe the art in nontraditional forms.

### BACKGROUND

For those who have visual impairments, viewing traditional pieces of art in conventional forms may not be possible. Traditional art forms, such as paintings or sculptures, rely on visual elements like color, shading, and perspective, which may not be visually observable to individuals with limited or no vision. While some art exhibits provide verbal descriptions or braille labels to accompany the artwork, these solutions are often limited in scope and fail to fully convey the artistic intent, texture, or emotional impact of the piece. Moreover, current technologies or tactile aids used to address this issue can be cumbersome, costly, or lack integration with the artwork itself. As a result, there is a lack of comprehensive systems that can offer a meaningful art experience to individuals with sensory disabilities.

Therefore, there is a need for a multi-sensory art system that allows individuals with sensory impairments to engage with and experience art in nontraditional and more inclusive ways. This disclosure addresses these deficiencies by integrating features that stimulate other senses, such as touch, sound, and/or smell, to create a more immersive and accessible art experience for all individuals, including individuals with sensory impairments.

### SUMMARY

According to an embodiment of this disclosure, a multi-sensory art system may have an art canvas having art sections having a front art canvas side and a back art canvas side. The art canvas may further comprise at least one tactile element placed on the front art canvas side within and/or around the art sections, and at least one sound element which may comprise a speaker. At least one touch sensor may be situated on the back art canvas side behind the art sections. Interacting with the art sections that have the at least one touch sensor located on the back art canvas side may activate the speaker for a predetermined limited time.

In another aspect, the art canvas may further comprise at least one fragrance element. The at least one fragrance element may comprise a fragrance mister holding at least one fragrance. Interacting with the art sections that have the at least one touch sensor located on the back art canvas side may activate the fragrance mister for a predetermined limited time.

In another aspect, the at least one fragrance element may further comprise a fan electrically connected to the fragrance mister and located in front of the fragrance mister to expel the at least one fragrance for the predetermined limited time.

In another aspect, the at least one fragrance element may be located near the front art canvas side.

In another aspect, the art canvas may further comprise at least one immersive element, wherein the touch sensor is electrically connected to the at least one immersive element. Interacting with art sections that have the at least one touch sensor located on the back art canvas side may activate the at least one immersive element for the predetermined limited time.

In another aspect, the at least one immersive element may comprise at least one of a heating element and/or a cooling element.

In another aspect, the speaker of the at least one sound element may be electrically connected to the at least one touch sensor. Interacting with the art sections that have the at least one touch sensor located on the back art canvas side may activate the at least one sound element for the predetermined limited time.

In another aspect, the at least one sound element may further comprise a sound board.

In another aspect, the sound board may have at least one pre-downloaded sound that plays for the predetermined limited time.

In another aspect, the touch sensor may be made of copper.

According to an embodiment of this disclosure, a multi-sensory art system may comprise an art canvas having art sections comprised of a front art canvas side and a back art canvas side. The art canvas may further comprise at least one tactile element placed on the front art canvas side within and/or around the art sections, at least one sound element electrically connected to a speaker, and at least one fragrance element comprising a fragrance mister holding at least one fragrance. The at least one fragrance element may be located near the back art canvas side. At least one copper touch sensor may be situated on the back art canvas side behind the art sections. Interacting with the art sections that have the at least one copper touch sensor located on the back art canvas side may activate the speaker for a predetermined limited time.

In another aspect, the at least one fragrance element further may comprise a fan electrically connected to the fragrance mister and located in front of the fragrance mister to expel the at least one fragrance for the predetermined limited time.

In another aspect, the art canvas may further comprise at least one immersive element, wherein the touch sensor is electrically connected to the at least one immersive element. Interacting with art sections that have the at least one touch sensor located on the back art canvas side may activate the at least one immersive element for the predetermined limited time.

In another aspect, the at least one immersive element may comprise at least one of a heating element and/or a cooling element.

In another aspect, the speaker of the at least one sound element may be electrically connected to the at least one touch sensor. Interacting with the art sections that have the at least one touch sensor located on the back art canvas side may activate the at least one sound element for the predetermined limited time.

In another aspect, the at least one sound element may further comprise a sound board.

In another aspect, the sound board may have at least one pre-downloaded sound that plays for the predetermined limited time.

According to an embodiment of this disclosure, a multi-sensory art system may comprise an art canvas having art sections comprised of a front art canvas side and a back art canvas side. The art canvas may further comprise at least one tactile element placed on top of the front art canvas side within the art sections, at least one sound element comprising a speaker, at least one fragrance element comprising a fragrance mister holding at least one fragrance, and at least one immersive element comprising a fan. The at least one fragrance element may be located near the back art canvas side. At least one copper touch sensor may be situated on the back art canvas side behind the art sections. Interacting with the art sections that have the at least one copper touch sensor located on the back art canvas side may activate the at least one sound element and the at least one fragrance element for a predetermined limited time.

In another aspect, the at least one sound element may further comprise a sound board that has at least one pre-downloaded sound that plays for the predetermined limited time.

In another aspect, interacting with the art sections that have the at least one copper touch sensor located on the back art canvas side may activate the at least one immersive element for a predetermined limited time.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective front view of a multi-sensory art system, according to an embodiment of this disclosure;

FIG. 2 is a perspective back view of a multi-sensory art system, according to an embodiment of this disclosure;

FIG. 3 is a perspective front view of a multi-sensory art system, according to an embodiment of this disclosure;

FIG. 4 is a perspective back view of a multi-sensory art system, according to an embodiment of this disclosure;

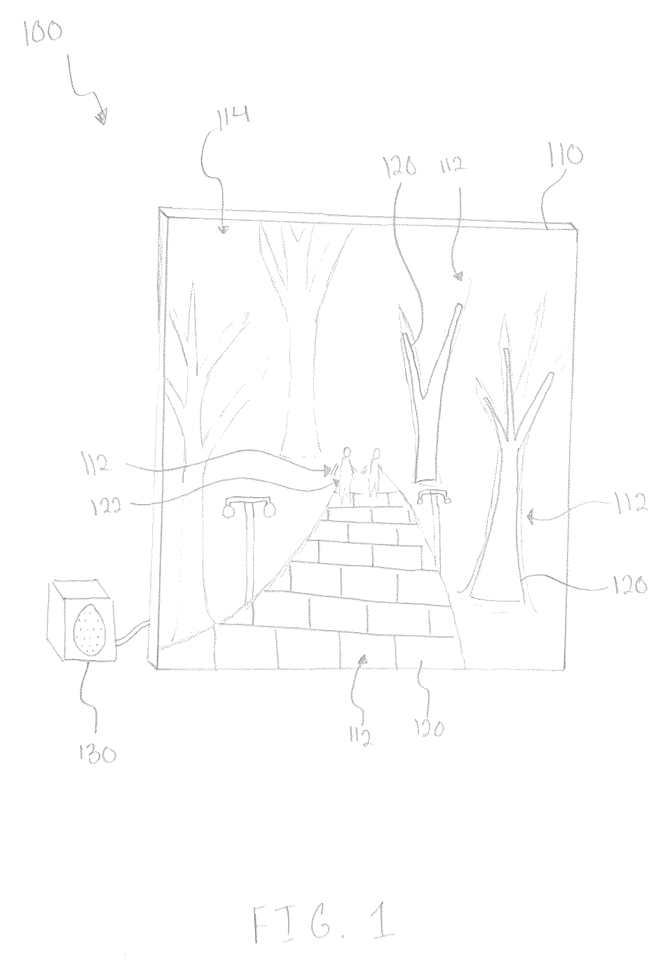

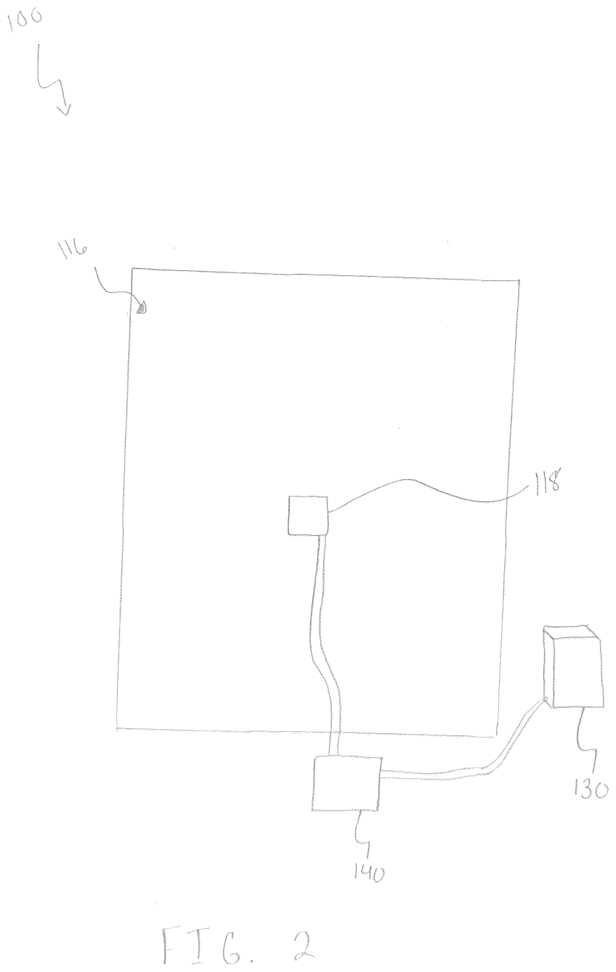

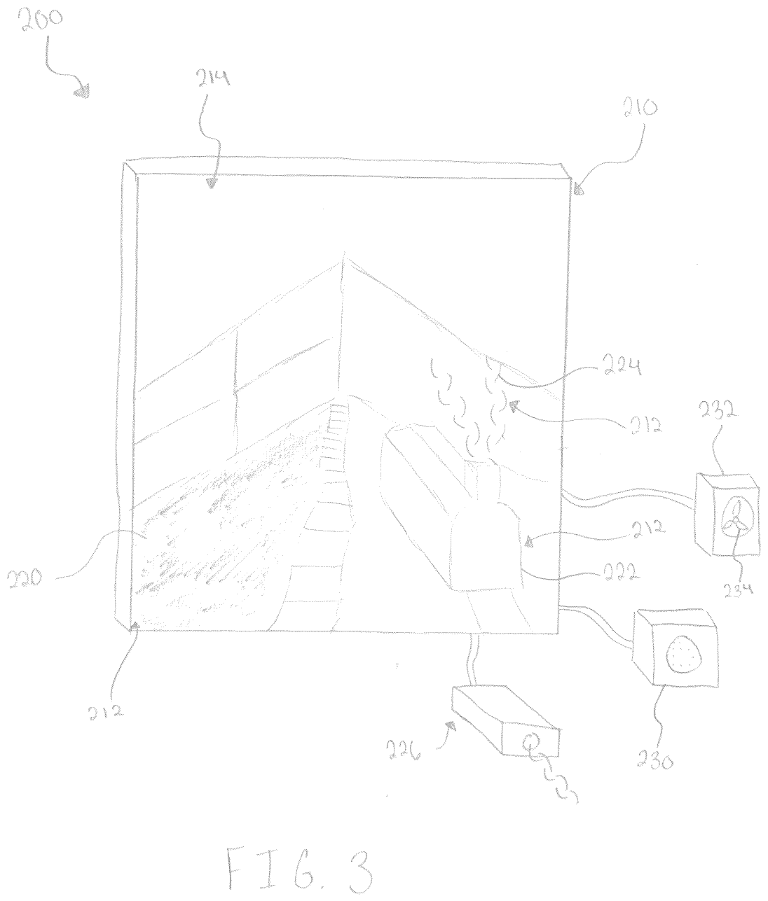

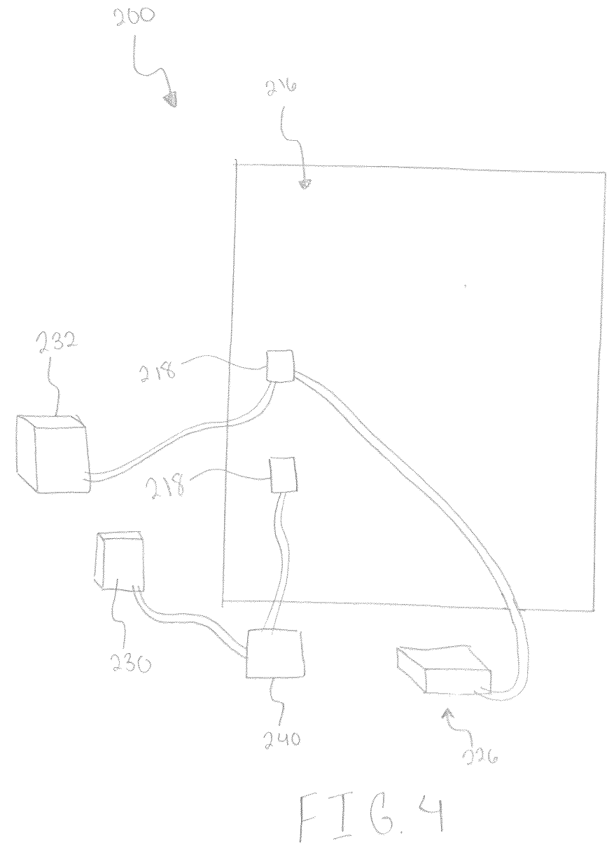

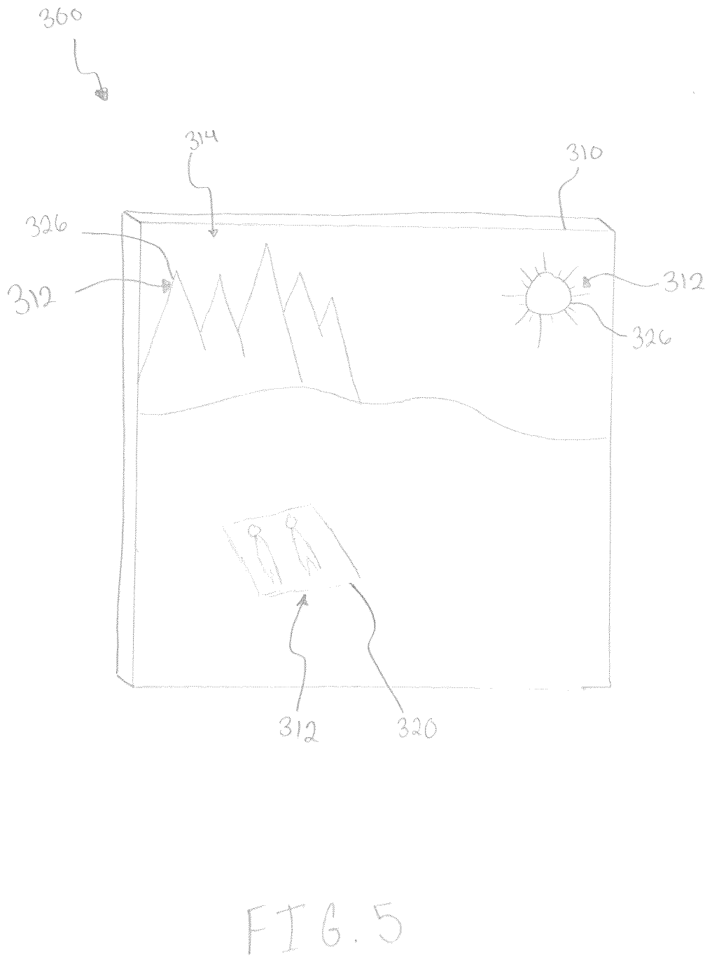

FIG. 3 is a perspective front view of a multi-sensory art system, according to an embodiment of this disclosure; and

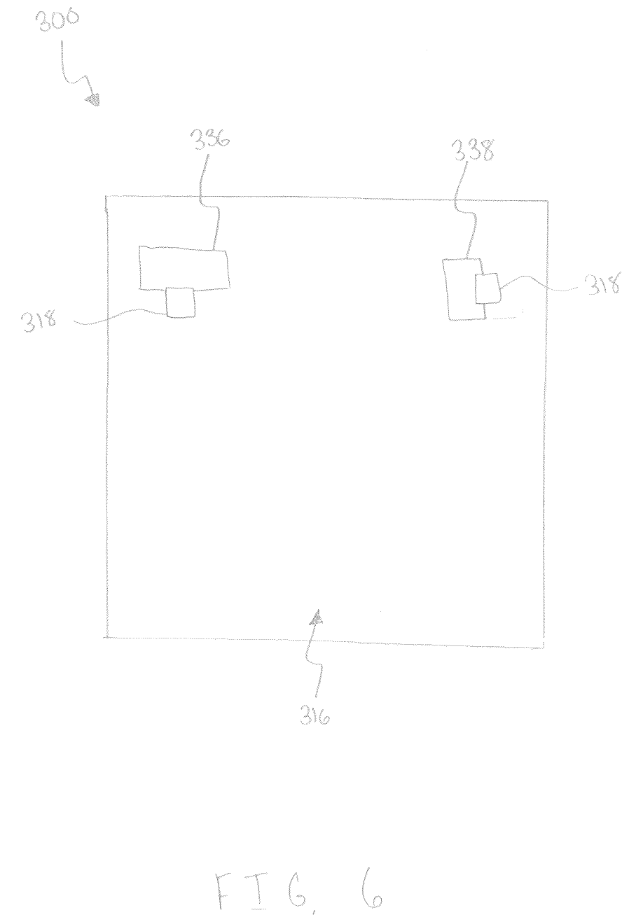

FIG. 4 is a perspective back view of a multi-sensory art system, according to an embodiment of this disclosure.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

The present disclosure relates to a multi-sensory art system 100, 200, 300 that may be configured to provide an inclusive and immersive experience for individuals engaging with artistic works. This system may be particularly beneficial for individuals with sensory disabilities, such as visual impairment, enabling them to interact with art installations through alternative and additional sensory pathways.

The multi-sensory art system 100, 200, 300 may include an artistic medium 110, 210, 310, which may have pre-existing artworks, which serves as the primary platform for sensory engagement. The canvas may be equipped with various interactive elements, including but not limited to at least one tactile element, at least one sound element, at least one fragrance element 224, and/or at least one immersive element. These elements may be designed to work together or independently to provide a holistic sensory experience. The system may further include control mechanisms and/or software interfaces that allow for customization of the sensory responses, making it adaptable to individual user preferences and requirements.

The multi-sensory art system 100, 200, 300 may span various applications. The system may be used in education settings, therapeutic settings, and art gallery settings. Those skilled in the art, however, will appreciate the various other uses for the multi-sensory art system 100, 200, 300 after having the benefit of this disclosure.

In various embodiments, the medium 110, 210, 310 may serve as the foundational structure of the multi-sensory art system 100, 200, 300, providing a physical surface on which various sensory elements may be arranged. In one aspect of this disclosure, the medium 110, 210, 310 may already have pre-drawn or pre-printed art on the medium 110, 210, 310, but the pre-drawn or pre-printed art may only be in a 2-dimensional form. In this example, the multi-sensory art system 100, 200, 300 may be placed in and/or around the medium 110, 210, 310. Those skilled in the art, however, will appreciate the various states that the medium 110, 210, 310 may be in before integrating the multi-sensory art system 100, 200, 300. Alternatively, an artist may specifically create the medium 110, 210, 310 with the intent that the multi-sensory art system 100, 200, 300 will be applied thereto, providing the artist with additional sensory options to consider when developing the art piece.

In another aspect, the canvas 110, 210, 310 may be divided into a front side 114, 214, 314 and a back side 116, 216, 316. The front side 114, 214, 314 may be on the opposite side as the back side 116, 216, 316. Additionally, the front side 114, 214, 314 may include the custom created or pre-drawn or pre-printed sections 112, 212, 312, which will be discussed in greater detail below. In one aspect of this disclosure, the front side 114, 214, 314 may be designed for direct user interaction, while the back side 116, 216, 316 may house the technical components, such as sensors and wiring, among other things, to implement the teachings of this disclosure. Those skilled in the art will appreciate the variety of purposes of each medium 110, 210, 310 side after having the benefit of this disclosure.

In some embodiments, the material composition of the artistic medium 110, 210, 310 may be canvas but may vary depending on its intended use. For example, the artistic medium 110, 210, 310 may be made of lightweight and durable materials, such as composite polymers or reinforced fabric, to ensure portability and longevity. Alternatively, the artistic medium 110, 210, 310 may include rigid materials, such as wood or metal, to provide structural stability for large-scale installations. Those skilled in the art will appreciate the variety of materials that may be used for the medium 110, 210, 310, after having the benefit of this disclosure.

In another aspect, the dimensions and shape of the medium may be customizable. In one embodiment, the medium may have a rectangular shape, suitable for wall-mounted displays. In another embodiment, it may be circular or irregularly shaped to match specific artistic themes. In other embodiments, modular designs may be included in multiple embodiments, allowing users to replace or rearrange sections of the medium to refresh the artwork or repair damaged components. Those skilled in the art will appreciate the various dimensions and shapes of the medium 110, 210, 310, after having the benefit of this disclosure.

In the same or different embodiments, the medium may feature integrated mounting or hanging mechanisms to facilitate installation in various environments. In one embodiment, these mechanisms may include hooks, brackets, or magnets, enabling the medium to be securely attached to walls, stands, or other surfaces.

The medium 110, 210, 310 may be subdivided into sections 112, 212, 312, where each may be designed to house specific sensory components. In various embodiments, each art section may correspond to a specific part of the painting or print. For example, if the medium 110 includes two people walking down a road with trees, each person may be its own art section, the road may be its own art section and the trees may be their own art section. Those skilled in the art, however, will appreciate the various sections 112, 212, 312 that may be defined within the medium 110, 210, 310, after having the benefit of this disclosure.

In some embodiments, the sections 112, 212, 312 may be visually or tactilely differentiated from surrounding sections to guide user interaction. For instance, raised borders or contrasting textures may delineate the sections 112, 212, 312, making them easily identifiable by touch.

In another aspect, each art section may incorporate at least one touch sensor 118, 218, 318, which may be situated on the back side 116, 216, 316. These sensors 118, 218, 318 may be configured to detect user interaction and activate one or more of at least one tactile element, at least one sound element, at least one fragrance element 224, and/or at least one immersive element, among other things. Those skilled in the art will appreciate the various elements that may be activated when a touch sensor 118, 218, 318 is engaged by a user.

In multiple embodiments, the sensors 118, 218, 318 may be comprised of copper and may use advanced technologies, such as capacitive or resistive touch sensing, to ensure precise and responsive operation. Those skilled in the art will appreciate the various types of touch sensors 118, 218, 318 that may be implemented within the multi-sensory art system 100, 200, 300, after having the benefit of this disclosure.

In one embodiment, the layout of the sections 112, 212, 312 may follow a thematic design. For example, the sections may represent different environments, such as forests, oceans, or cities, with each section incorporating sensory elements that reflect its theme. In another embodiment, the sections may be arranged in abstract patterns, allowing users to explore the artwork in a non-linear fashion.

The size and shape of the sections 112, 212, 312 may vary depending on the medium design. In multiple embodiments, larger sections may be used for prominent features, while smaller sections may highlight intricate details. Those skilled in the art will appreciate the various examples of sections 112, 212, 312 after having the benefit of this disclosure.

The multi-sensory art system 100, 200, 300 may include at least one tactile element, which may be positioned on the front side 114, 214, 314 within or around the sections 112, 212, 312. These tactile elements may provide physical representations of the artwork, which may enable users to perceive shapes, patterns, and textures through touch. For example, the tactile elements may be real leaves, tree branches, fabrics, hairs, pebbles, or any other actual physical representation of the depicted element. Those skilled in the art will appreciate the various purposes that the at least one tactile element 120, 220, 320 may be used for, after having the benefit of this disclosure.

In various embodiment, the tactile elements may be made from materials such as rubber, silicone, or textured fabric, offering a variety of tactile sensations. These elements may include embossed shapes, raised patterns, or textured surfaces that correspond to the artistic theme of the medium, among other things. For example, a forest-themed canvas may feature tactile elements resembling tree bark or leaves. However, those skilled in the art will appreciate the various ways that the at least one tactile element 120, 220, 320 may be implemented to allow the user to “feel” what is on the medium 110, 210, 310, after having the benefit of this disclosure.

In multiple embodiments, the tactile elements may be interactive, allowing users to press, slide, or manipulate them to trigger other sensory responses. For example, pressing a tactile element 120, 220, 320 may activate one or more of at least one sound element 122, 222 and/or at least one fragrance element 224, which may create a multisensory feedback response to the user. The placement and design of these elements may be customizable, allowing artists to experiment with different tactile effects that correspond with the theme of the work.

In one embodiment, the tactile elements may be removable or interchangeable, enabling users to refresh the artwork or adapt it to new themes. Those skilled in the art will appreciate the various examples of tactile elements, after having the benefit of this disclosure.

The multi-sensory art system 100, 200, 300 may include at least one sound element, which may be integrated into the medium 110, 210, 310 to provide auditory feedback. In one embodiment, the sound element 122, 222 may comprise a speaker 130, 230 that plays pre-recorded audio tracks, such as music, environmental sounds, or descriptive narratives. Those skilled in the art will appreciate the various sounds that the at least one sound element 122, 222 may play, after having the benefit of this disclosure.

In multiple embodiments, the sound element 122, 222 may include a soundboard 140, 240 that stores and/or manages audio files. In the same or different embodiments, users may upload custom sounds or select from a library of pre-downloaded options, allowing for personalized auditory experiences.

In some elements, the at least one sound element 122, 222 may include a speaker 130, 230. The speaker 130, 230 may be positioned in one or more locations behind, around, and/or in front of the medium 110, 210, 310. The speaker 130, 230 may be positioned to optimize sound projection. Further still, this disclosure contemplates utilizing multiple speakers as well to provide different sound responses from different areas relative to the medium 110, 210, 310. Those skilled in the art will appreciate the various speaker 130, 230 locations after having the benefit of this disclosure.

In some aspects of this disclosure, the audio output of the at least one sound element 122, 222 may be synchronized with user interaction. For example, in one embodiment, touching a specific art section may trigger a corresponding sound, such as the chirping of birds or the sound of ocean waves. In various embodiments, the volume and duration of the audio may be adjustable to suit different settings or user preferences. Those skilled in the art will appreciate the various volumes and durations of the audio coming from the at least one sound element 122, 222 after having the benefit of this disclosure.

In multiple embodiments, the sound element 122, 222 may support advanced features, such as spatial audio or real-time sound modulation, to enhance the immersive quality of the system. Those skilled in the art will appreciate the various examples of sound elements after having the benefit of this disclosure.

The multi-sensory art system 100, 200, 300 may include at least one fragrance element 224 which may engage the olfactory senses of a user. In some embodiments, the fragrance element 224 may comprise a fragrance mister 232 capable of dispersing various scents into the surrounding environment. This element may be positioned near the back side 116, 216, 316 and be configured to release fragrance when a user interacts with specific sections 112, 212, 312. However, those skilled in the art will appreciate the various positions the fragrance mister 232 as well as how many fragrance misters 232 are situated in and around the medium 110, 210, 310, after having the benefit of this disclosure.

In embodiments contemplated herein, the fragrance mister 232 may hold a plurality of fragrances, each associated with a particular art section. For example, a garden-themed canvas may dispense floral scents such as rose or lavender while an ocean-themed section may release a refreshing marine aroma. Further still, in one aspect of this disclosure users may switch or refill the fragrances as needed, ensuring the system remains adaptable to different themes and preferences.

In some aspects, the fragrance element 224 may further include a fragrance fan 234, which may be electrically connected to the mister to aid in dispersing the fragrance. In one embodiment, the fragrance fan 234 may be located in front of the mister, directing the scent toward the user for a more immediate sensory experience. This configuration may allow the fragrance to reach users in various positions around the canvas.

In another embodiment, the activation of the fragrance element 224 may be timed to ensure that the scents do not overpower the environment. For example, the fragrance mister 232 may release scent for a predetermined limited time, such as 5-10 seconds, after which it deactivates until the user interacts with the canvas again. Those skilled in the art will appreciate the various activation sequences, after having the benefit of this disclosure.

The multi-sensory art system 100, 200, 300 may include at least one immersive element 226, 326 to enhance the user's overall experience. These elements may provide additional sensory feedback, complementing the other elements of the system. In some embodiments, the immersive element 226, 326 may be activated through touch sensor 118, 218, 318s located on the back side 116, 216, 316 behind the sections 112, 212, 312.

The immersive element 226, 326 may include components such as at least one cooling element, at least one heating element, lighting effects, motion mechanisms, and/or environmental simulations such as mist or smoke, among other things. For instance, a canvas designed to depict a rainstorm may include immersive elements such as soft lighting to mimic lightning or vibration effects to simulate raindrops. These features may activate for a predetermined limited time upon user interaction. Those skilled in the art, however, will appreciate the various components that may be included as the at least one immersive element, after having the benefit of this disclosure.

In embodiments, the at least one immersive element 226, 326 may be designed to adapt to various artistic themes. In one embodiment, a forest-themed canvas may feature simulated breezes generated by fans, while a winter-themed canvas may include soft, cool airflows to evoke the sensation of snow. The immersive element 226, 326 may be modular, allowing artists or users to incorporate additional features as needed.

In another embodiment, the immersive element 226, 326 may include interactive feedback mechanisms, such as sensors that adjust the intensity or duration of the effect based on the user's proximity or movement. Those skilled in the art will appreciate the various additional elements of the at least one immersive element, after having the benefit of this disclosure.

The multi-sensory art system 100, 200, 300 may include at least one heating element 336 to provide thermal feedback, which may further enrich the sensory experience. In one embodiment, the heating element 336 may be embedded within or near the sections 112, 212, 312 on the back side 116, 216, 316 and electrically connected to the touch sensor 118, 218, 318s. Interaction with these sections may activate the heating element 336 for a predetermined time.

In multiple embodiments, the heating element 336 may be designed to complement the artistic theme of the medium. For example, a desert-themed section may emit gentle warmth to simulate the sensation of sunlight. Alternatively, a medium depicting a campfire scene may include heating elements that produce localized warmth near the “flame” portions of the artwork. Those skilled in the art will appreciate the various uses of the at least one heating element, after having the benefit of this disclosure.

In some embodiments, the heating element 336 may include safety features to prevent overheating or accidental burns. In one embodiment, the heating element 336 may be equipped with temperature sensors and automatic shutoff mechanisms to ensure user safety. The intensity of the heat may also be adjustable, allowing for customization based on user preferences or environmental conditions.

In embodiments, the heating element 336 may be constructed from materials such as conductive polymers, ceramic heaters, and/or flexible heating pads, depending on the design and functionality of the artistic medium. Those skilled in the art will appreciate the various heating element 336 materials that may be used, after having the benefit of this disclosure.

The multi-sensory art system 100, 200, 300 may include at least one cooling element 338 which may provide contrasting thermal feedback to the at least one heating element. In one embodiment, the at least one cooling element 338 may be embedded within the medium 110, 210, 310 or positioned near the back side 116, 216, 316 and electrically connected to the touch sensor 118, 218, 318. Interaction with designated sections 112, 212, 312 may activate the cooling element 338 for a predetermined limited time.

In multiple embodiments, the cooling element 338 may include technologies such as thermoelectric coolers, airflow systems, and/or cooling gels. Those skilled in the art will appreciate the various cooling element 338 materials that may be used, after having the benefit of this disclosure. In one aspect, a canvas depicting a winter scene may incorporate cooling elements that emit a cool sensation, simulating the feeling of snow or ice. Similarly, an underwater-themed canvas may use cooling elements to evoke the sensation of cool ocean water.

In some embodiments, the cooling element 338 may also be paired with other sensory components for a more immersive experience. In one embodiment, the cooling element 338 may work alongside a sound element 122, 222 that plays the sound of wind or waves, reinforcing the artistic theme. These combined effects may transport the user into the depicted scene, enhancing the overall sensory engagement.

In multiple embodiments, the cooling element 338 may include features such as temperature regulation, energy-saving modes, and/or automatic shutoff systems. Those skilled in the art will appreciate the various examples of safety features of the at least one cooling element 338 after having the benefit of this disclosure.\

Another embodiment of this disclosure includes providing a kit for creating a multi-sensory art system on an artistic medium. The kit may be packaged so a user can purchase a single kit that has some or all of the components described herein except the artistic medium. For example, in one embodiment the kit includes at least one tactile element, at least one touch sensor, at least one sound element, and in some embodiments at least one fragrance element. As described herein, the kit is configurable so a user can adapt an artistic medium with the components provided in the kit so the artistic medium can produce feedback to an observer that includes observations that are more than visual. While all observers may benefit from an artistic medium that has been adapted with the kit discussed herein, adapting an artistic medium with the kit disclosed herein may be particularly helpful in providing opportunities for observers with visual impairments to observe the artistic medium in forms other than visual.

In one aspect of this embodiment, an artist may obtain a kit and specifically design an artistic medium incorporating the components provided therein to further express the intended vision of the artist. In this configuration, the artist can take advantage of the available sensory responses that are provided through the tactile element and touch sensor, sound element, and/or fragrance element, among other components discussed herein, to create an artistic medium that creates an immersive experience for the observer.

Another embodiment of this disclosure is a method for creating a multi-sensory art system from a known artistic medium. A known artistic medium may be a known work of art that is historically primarily visual. For example, a known artistic medium may be a famous painting. Regardless of the form of the known artistic medium, this method includes coupling at least one tactile element to an art section on the known artistic medium. The art section may be a distinct section of the known artistic medium that can be represented with one or more of the components discussed herein. For example, the art section may be a section of water on the known artistic medium. In this example, the tactile element may be a smooth and wavy feature that a user can touch and associate with a water feature.

This method also includes positioning a touch sensor on the back side of the known artistic medium behind the art section. The sensor may further be connected to a one or more sound element, fragrance element, and/or immersive element discussed herein. In this example, the sound element, fragrance element, and/or immersive element may be specifically configured to be associated with the art section. For example, when the art section is a water feature and the tactile element provides a tactile input indicative of the art section, the touch sensor may identify when an observer engages the tactile feature and provide a response through the sound element, fragrance element, and/or immersive element to supplement non-visual feedback for the observer. For example, when the tactile element is engaged by the observer, the sound element may play the sound of waves on a beach while a salty beach fragrance is produced by the fragrance element and the tactile element is cooled by a cooling immersive element.

While a specific example of a tactile element and corresponding response are discussed herein, a person skilled in the art understands that the teachings of this disclosure contemplate providing any extra-sensory response to a user that may correspond with an art section.

Another aspect of this disclosure may include displaying the known artistic medium so a visually impaired user can engage the tactile element to activate the at least one sound element, at least one fragrance element, and at least one immersive element to provide a sensory experience to the visually impaired user that represents the art section of the known artistic medium. This may include creating a display for the known artistic medium that is easily accessible for a user to touch the tactile element and observe the additional responses generated when engaged as discussed herein.

While one art section is described in detail herein, this method contemplates coupling at least one additional tactile element on top of an additional art section of the known artistic medium. This may include positioning at least one additional touch sensor on the back side of the known artistic medium behind the additional art section and connecting the at least one additional touch sensor to one or more of the sound element, fragrance element, and immersive element. The additional tactile element and corresponding additional sensor may provide an opportunity for interacting with the additional tactile element to engage the additional touch sensor to activate one or more of the sound element, the fragrance element, and immersive element to provide outputs that are distinct from those provided when the touch sensor is engaged. This disclosure contemplates using any number of tactile elements and corresponding sensors to provide any number of enhanced responses to an observer of the artistic medium.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A multi-sensory art system, comprising:
an artistic medium having one or more art section, the artistic medium comprising a front side and a back side, the artistic medium further comprising:
at least one tactile element placed on the front side within and/or around the art section, the tactile element configured to be a tactile representation of the art section;
at least one sound element comprising a speaker; and
at least one touch sensor positioned on the back side behind the art section;
wherein interacting with the tactile element of the art section engages the at least one touch sensor to activate the speaker for a predetermined limited time.

2. The system of claim 1, wherein the artistic medium further comprises:
at least one fragrance mister holding at least one fragrance;
wherein interacting with the art section to engage the at least one touch sensor activates the fragrance mister for a predetermined time.

3. The system of claim 2, further comprising a fan electrically connected to the fragrance mister and positioned to expel the at least one fragrance from the fragrance mister towards the front side for the predetermined limited time.

4. The system of claim 3, wherein the at least one fragrance element is located near the front side.

5. The system of claim 1, wherein the artistic medium further comprises:
at least one immersive element, wherein the touch sensor is electrically connected to the at least one immersive element; and
wherein interacting with art section engages the at least one touch sensor and activates the at least one immersive element for the predetermined limited time.

6. The system of claim 5, wherein the at least one immersive element comprises one or more of a heating element and/or a cooling element.

7. The system of claim 1, wherein the speaker of the at least one sound element is electrically connected to the at least one touch sensor; and
wherein interacting with the art section engages the at least one touch sensor which activates the at least one sound element for the predetermined limited time.

8. The system of claim 7, wherein the at least one sound element further comprises a sound board.

9. The system of claim 8, wherein the sound board has at least one pre-downloaded sound that plays for the predetermined limited time.

10. The system of claim 1, wherein the touch sensor is made of copper.

11. A kit for creating a multi-sensory art system on an artistic medium, comprising:
at least one tactile element configured to be placed on a front side of the artistic medium within and/or around an art section defined thereon, the tactile element further configured to be a tactile representation of material depicted in the art section;
at least one touch sensor configured to be situated on a back side of the artistic medium behind the art section such that the touch sensor identifies user interaction with the tactile element;
at least one sound element electrically connected to a speaker and the touch sensor, the sound element configured to selectively play a user-selected sound when the touch sensor identifies user interaction with the tactile element; and
at least one fragrance element comprising a fragrance mister holding at least one fragrance, the fragrance element configured to selectively disperse a fragrance when the touch sensor identifies user interaction with the tactile element;
wherein the tactile element, sound element, and fragrance element are configured to be applied to the artistic medium to provide an immersive experience for a visually impaired user that represents the art section engaged by the user.

12. The kit of claim 11, wherein the at least one fragrance element further comprises a fan electrically connected to the fragrance mister and configured to expel the at least one fragrance.

13. The kit of claim 11, further comprising:
at least one immersive element, wherein the touch sensor is configured to be electrically connected to the at least one immersive element; and
wherein engaging the at least one touch sensor activates the at least one immersive element for the predetermined limited time.

14. The kit of claim 13, wherein the at least one immersive element comprises at least one of a heating element and/or a cooling element.

15. The kit of claim 11, wherein the speaker of the at least one sound element is electrically connected to the at least one touch sensor; and
wherein engaging the at least one touch sensor activates the at least one sound element for the predetermined limited time.

16. The kit of claim 15, wherein the at least one sound element further comprises a sound board.

17. The kit of claim 16, wherein the sound board has at least one pre-downloaded sound that plays for the predetermined limited time.

18. A method for creating a multi-sensory art system, comprising:
providing a known artistic medium having at least one art section therein, the known artistic medium comprised of a front side and a back side; coupling at least one tactile element to the art section on the front side of the known artistic medium;
positioning at least one touch sensor on the back side of the known artistic medium behind the art section; and connecting the at least one touch sensor to at least one sound element comprising a speaker, at least one fragrance element comprising a fragrance mister holding at least one fragrance, and at least one immersive element;
wherein interacting with the art section engages the at least one touch sensor and activates the at least one sound element, the at least one fragrance element, and the at least one immersive element for a predetermined time.

19. The method of claim 18, further comprising displaying the known artistic medium so a visually impaired user can engage the tactile element to activate the at least one sound element, at least one fragrance element, and at least one immersive element to provide a sensory experience to the visually impaired user that represents the art section of the known artistic medium.

20. The method of claim 19, further comprising:
coupling at least one additional tactile element on top of an additional art section on the front side of the known artistic medium;
positioning at least one additional touch sensor on the back side of the known artistic medium behind the additional art section; and
connecting the at least one additional touch sensor to the at least one sound element, at least one fragrance element, and at least one immersive element;
wherein, interacting with the additional tactile element engages the additional touch sensor to activate the at least one sound element, the at least one fragrance element, and the at least one immersive element to provide outputs that are distinct from those provided when the touch sensor is engaged.
